(19) United States
(12) Patent Application Publication
(10) Pub. No.: US 2026/0208722 A1
(43) Pub. Date: Jul. 23, 2026

(54) METHOD FOR MANAGING A HYBRID POWERTRAIN FOR A HYDROGEN MOTOR VEHICLE AND ASSOCIATED POWERTRAIN

(71) Applicant: AMPERE S.A.S., Boulogne Billancourt (FR)

(72) Inventor: David GERARD, Guyancourt (FR)

(73) Assignee: AMPERE S.A.S., Boulogne Billancourt (FR)

(21) Appl. No.: 19/140,058

(22) PCT Filed: Dec. 14, 2023
(86) PCT No.: PCT/EP2023/085862

§ 371 Date: Jun. 17, 2025

(30) Foreign Application Priority Data
Dec. 21, 2022 (FR) FR2214026

(51) Int. Cl. B60W 20/15; B60W 10/06; B60W 10/28; H01M 8/04082; H01M 8/04492; H01M 8/04746; H01M 8/04828

(52) U.S. Cl. CPC B60W 20/15; B60W 10/06; B60W 10/28; H01M 8/04201; H01M 8/04492; H01M 8/04753; H01M 8/04828; B60W 2510/28; B60W 2710/06; B60W 2710/28; H01M 2250/20

(57) ABSTRACT

A method manages a hybrid powertrain of a hydrogen motor vehicle. The hybrid powertrain includes an internal combustion engine, a fuel cell, a hydrogen storage tank, and a line connecting an air outlet of the fuel cell to an air inlet of the internal combustion engine. The line has a cutoff valve. The method includes controlling the shutdown of the fuel cell, stopping the internal combustion engine, opening the cutoff valve when the fuel cell and the internal combustion engine are stopped, and running the internal combustion engine without injecting hydrogen from the storage tank in order to draw, via the line, the fluids present in the fuel cell to the internal combustion engine.

The present invention concerns, in general, motor vehicles using hydrogen as an energy source and, in particular, hybrid motor vehicles incorporating an internal combustion engine as well as a fuel cell, both supplied with hydrogen.

More precisely, the invention concerns a method for managing a hybrid powertrain of a hydrogen motor vehicle, comprising an internal combustion engine and a fuel cell, and also an associated powertrain.

With the aim of proposing an alternative to fossil fuels, hydrogen technology has excited great interest, in particular in the automotive sector.

There are now various architectures for motor vehicles using hydrogen as an energy source.

According to an example, document US 20140001033 describes a system using hydrogen as a secondary energy source. For this, water is drawn into a fuel cell which generates a mixture of hydrogen and oxygen. The resulting hydrogen is mixed with the fuel which supplies the internal combustion engine.

Other vehicles use hydrogen as the sole energy source.

In particular, in reverse operation, a fuel cell may be coupled to an electric battery which it supplies with an electric current produced from hydrogen and oxygen. The electric battery can thus deliver electrical energy to an electric motor, in particular during a start-up phase or transitory operating phases.

The advantages of the fuel cell are in particular a very high efficiency at partial load, i.e. during requests for low power, and the generation of electrical power which can be used in an electric motor in order to propel the vehicle without any legislatively restricted polluting emissions.

The operation of other vehicles is based solely on the combustion of hydrogen in an internal combustion engine.

The internal combustion engine has the advantage of being able to generate high power levels with a high efficiency in the case of high loads. On the other hand however, the internal combustion engine produces small quantities of legislatively restricted pollutants.

In order to benefit from the advantages of the two structures, some hybrid hydrogen vehicles incorporate an internal combustion engine and an electric motor coupled to a battery, which is itself supplied by a fuel cell. The hydrogen is then used as the sole energy source by the internal combustion engine and by the fuel cell.

However, when the fuel cell is shut down, water may still be present inside it. When shut down, the prolonged presence of water affects its stability and service life.

In particular, when the exterior temperature is negative, the water still present freezes, which disrupts its operation by preventing its restarting.

The object of the invention is therefore to remedy these drawbacks and propose a strategy for shutting down the fuel cell while ensuring optimum restarting, irrespective of whether the exterior temperature is positive or negative, which strategy is intended to prolong its service life and ensure its stability.

A method is therefore proposed for managing a hybrid powertrain of a hydrogen motor vehicle, comprising an internal combustion engine, a fuel cell, a hydrogen storage tank and a pipe C1 which connects an air outlet of the fuel cell to an air inlet of the internal combustion engine and comprises a cut-off valve V1, the method comprising the following steps:
a) provoking the shut-down of the fuel cell;
b) provoking the shut-down of the internal combustion engine;
c) when the fuel cell and the internal combustion engine have shut down, opening the cut-off valve V1; and
d) when the cut-off valve V1 is open, running the internal combustion engine without the injection of hydrogen originating from the tank, in order to draw the fluids present in the fuel cell towards the internal combustion engine via the pipe C1.

In an embodiment, the powertrain may comprise a pipe C2 which connects a hydrogen outlet of the fuel cell to the air inlet of the internal combustion engine and comprises a cut-off valve V2, the step c) comprising the opening of the cut-off valve V2 as well as the valve V1, in order to draw the fluids present in the fuel cell towards the internal combustion engine via the pipe C2 also in step d).

According to a feature, the operation of the internal combustion engine in step d) may be maintained during a predetermined time interval.

According to another feature, the operation of the internal combustion engine in step d) may be maintained until the humidity level in the fuel cell is less than or equal to a predetermined threshold value.

The invention also concerns a hybrid powertrain for a hydrogen motor vehicle, comprising:
an internal combustion engine;
a fuel cell;
a hydrogen storage tank;
a pipe C1 which connects an air outlet of the fuel cell to an air inlet of the internal combustion engine and comprises a cut-off valve V1 for the selective passage of fluids present in the fuel cell from said air outlet towards the internal combustion engine; and
a control device configured to provoke the opening of the cut-off valve V1 when the fuel cell and the internal combustion engine have shut down, and to run the internal combustion engine without the injection of hydrogen originating from the storage tank, in order to draw the fluids present in the fuel cell towards the internal combustion engine via the pipe C1.

In an embodiment, the powertrain may comprise a pipe C2 which connects a hydrogen outlet of the fuel cell to the air inlet of the internal combustion engine and comprises a cut-off valve V2 for the selective passage of fluids present in the fuel cell from said hydrogen outlet towards the internal combustion engine, the control device being configured to provoke the opening of the cut-off valve V2 as well as the valve V1 before the start-up of the internal combustion engine without the injection of hydrogen, in order to draw the fluids present in the fuel cell towards the internal combustion engine also via the pipe C2.

Advantageously, the powertrain may comprise a recirculation unit connected to the fuel cell for the recirculation of hydrogen from the hydrogen outlet towards a hydrogen inlet of the fuel cell, the recirculation unit being connected to the pipe C2.

Preferably, the pipe C2 is connected to the pipe C1 upstream of the air inlet of the internal combustion engine.

Preferably, the powertrain comprises at least one condenser positioned on the pipe C1 and/or the pipe C2.

Advantageously, the internal combustion engine may be coupled to a turbocompressor positioned on the pipe C1, upstream of the air inlet of the internal combustion engine and downstream of the fuel cell.

The invention also concerns a motor vehicle comprising a powertrain as described above.

Further aims, advantages and characteristics will arise from the following description which is given purely for illustrative purposes and with reference to the appended drawings, in which:

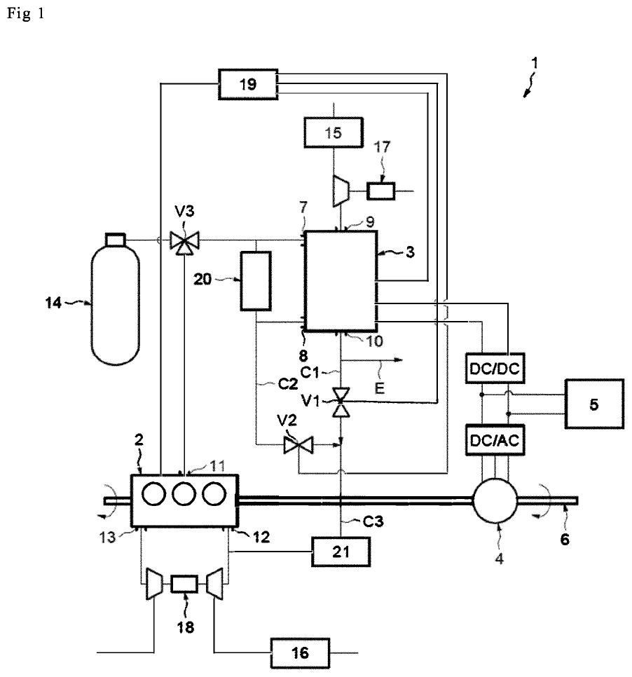

FIG. 1 illustrates a hybrid powertrain for a hydrogen motor vehicle according to an embodiment of the invention.

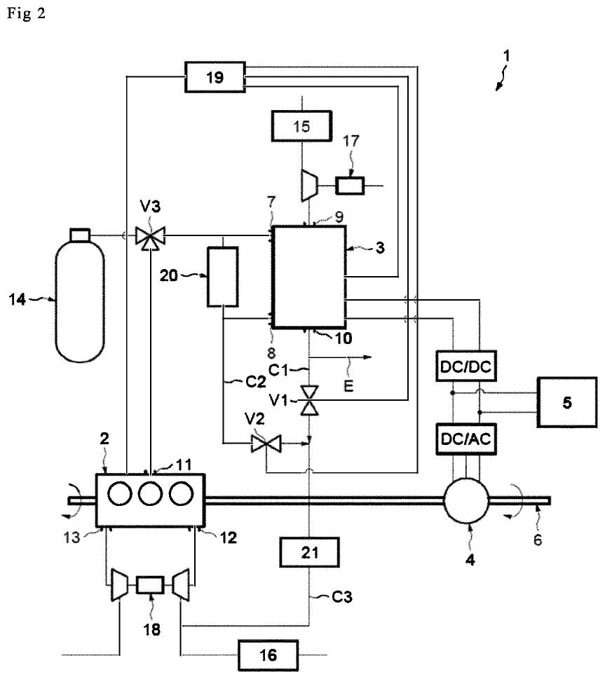

FIG. 2 illustrates a hybrid powertrain for a hydrogen motor vehicle according to another embodiment of the invention.

Also, the expression “at least one” used in the present description is equivalent to the expression “one or more”.

In the present invention, the terms “upstream” and “downstream” are understood with respect to the flow direction of the fluids drawn from the fuel cell by the internal combustion engine.

FIG. 1 illustrates a powertrain 1 for a motor vehicle.

In the example illustrated, hydrogen is the sole energy source of the motor vehicle.

Naturally, it may be that the powertrain is incorporated in a motor vehicle using one or more energy sources other than hydrogen.

The powertrain 1 comprises an internal combustion engine 2 incorporating a combustion chamber, and a fuel cell 3, both using hydrogen as an energy source.

In the example illustrated, the powertrain 1 comprises an electric motor 4 coupled to a battery 5, which is itself coupled to the fuel cell 3.

The powertrain 1 is hybrid, so both the internal combustion engine 2 and the electric motor 4 of the hybrid powertrain 1 are rotationally coupled to a transmission shaft 6 in order to propel the motor vehicle.

The fuel cell 3 comprises a hydrogen inlet 7 and a hydrogen outlet 8, as well as an air inlet 9 and an air outlet 10.

The hydrogen inlet 7 and the hydrogen outlet 8 are, advantageously, respectively an anodic hydrogen inlet 7 and an anodic hydrogen outlet 8, positioned in contact with an anode of the fuel cell 3.

The air inlet 9 and the air outlet 10 are, advantageously, respectively a cathodic air inlet 9 and a cathodic air outlet 10, positioned in contact with a cathode of the fuel cell 3.

The fuel cell 3 generates an electric current and water from oxygen present in the air and from hydrogen. The electric current generated may serve to supply the battery 5, which itself supplies the electric motor 4.

Advantageously, the internal combustion engine 2 comprises a hydrogen inlet 11, an air inlet 12 and an exhaust gas outlet 13.

Preferably, the powertrain 1 comprises at least one storage tank 14 connected to the hydrogen inlet 7 of the fuel cell 3 and to the hydrogen inlet 11 of the internal combustion engine 2, in order to supply them with hydrogen.

In the example illustrated, a three-way valve V3 allows the selective passage of hydrogen originating from the storage tank 14 towards the fuel cell 3 or the internal combustion engine 2.

The air introduced into the fuel cell 3 and into the internal combustion engine may, advantageously, be exterior air collected when the vehicle is travelling, which air preferably passes through an air filter, respectively 15 and 16, upstream of the fuel cell 3 and upstream of the internal combustion engine 2.

Preferably, a compressor 17 is arranged upstream of the air inlet 9 of the fuel cell 3.

Preferably, a turbocompressor 18 is arranged upstream of the air inlet 12 of the internal combustion engine 2.

In addition, the powertrain comprises a pipe C1 connecting the air outlet 10 of the fuel cell 3 to the air inlet 12 of the internal combustion engine 2.

A cut-off valve V1 is positioned on the pipe C1 for the selective passage of fluids present in the fuel cell 3 from the air outlet 10 of the fuel cell 3 towards the internal combustion engine 2.

Advantageously, an exhaust pipe E may be arranged on the pipe C1 upstream of the cut-off valve V1, for the escape of air originating from the fuel cell 3.

Furthermore, a control device 19 is configured to provoke the opening of the cut-off valve V1 when the fuel cell 3 and the internal combustion engine 2 have shut down.

The control device 19 is also configured to run the internal combustion engine 2 by means of an electric motor such as the motor 4, for example, without the injection of hydrogen originating from the tank 14, in order to draw the fluids present in the fuel cell 3 towards the internal combustion engine 2.

As illustrated in FIG. 1, the powertrain 1 may comprise a recirculation unit 20 connected to the hydrogen outlet 8 and to the hydrogen inlet 7 of the fuel cell 3.

The recirculation unit 20 advantageously incorporates a pump and allows the recirculation of hydrogen not oxidized by the fuel cell 3 from the hydrogen outlet 8 towards the hydrogen inlet 7.

In the example illustrated, a pipe C2 connects the hydrogen outlet 8 of the fuel cell 3 to the air inlet 12 of the internal combustion engine 2.

Furthermore, a cut-off valve V2 is arranged on the pipe C2 and allows the selective passage of fluids present in the fuel cell 3 from the hydrogen outlet 8 of the fuel cell 3 towards the internal combustion engine 2.

The control device 19 is preferably configured to provoke the opening of the cut-off valve V2 as well as the valve V1, before running the internal combustion engine 2 without the injection of hydrogen.

The drawing of fluids via the pipe C2 as well as the drawing via the pipe C1 allows an increase in efficiency of the evacuation of the water from the fluids present in the fuel cell 3. In the example illustrated, the recirculation unit 20 is connected to the pipe C2.

The pipe C2 may be connected to the pipe C1 upstream of the air inlet 12 of the internal combustion engine 2, such that the pipes C1 and C2 form a common portion C3 which opens into the internal combustion engine 2 via the air inlet 12.

Preferably, the powertrain comprises at least one condenser 21 positioned on the pipe C1 and/or the pipe C2.

In the example illustrated, the condenser is positioned downstream of the connection of the pipes C1 and C2, on the common portion C3.

The condenser 21 may help evacuate the liquid water from the fluids drawn towards the internal combustion engine 2.

The invention also concerns a method for managing a powertrain 1 as described above, and comprising the following steps:
a) provoking the shut-down of the fuel cell 3;
b) provoking the shut-down of the internal combustion engine 2;
c) when the fuel cell 3 and the internal combustion engine 2 have shut down, opening the cut-off valve V1; and
d) when the cut-off valve V1 is open, running the internal combustion engine 2 without the injection of hydrogen originating from the storage tank 14, in order to draw the fluids present in the fuel cell 3 towards the internal combustion engine 2.

The combustion engine 2 therefore functions as a vacuum pump, drawing the fluids present in the fuel cell 3, in particular air and water, towards the combustion chamber of the internal combustion engine 2.

The management method according to the invention thus allows drying of the fuel cell after it has been shut down. In particular on restart, and in particular when the exterior temperature is negative, this drying allows there to be no significant quantities of frozen water in the fuel cell 3 which would prevent its restart. Drying the fuel cell 3 thus facilitates the restart and improves the service life of the fuel cell 3.

Steps a) and/or b) may be provoked by the control device 19 in response to an instruction by the driver to shut down the motor vehicle.

Furthermore, steps a) and/or b) may be provoked simultaneously or successively. Step b) may be carried out before step a) or vice versa.

Preferably, the opening of the valve V1 is provoked by the control device 19.

In an embodiment, the powertrain 1 comprises a recirculation unit 20.

Preferably, step c) comprises the opening of the cut-off valve V2 as well as the valve V1, which may also be provoked by the control device 19.

According to another feature, the operation of the internal combustion engine 2 in step d) may be maintained until the humidity level in the fuel cell 3 is less than or equal to a predetermined threshold value.

The predetermined threshold value may advantageously be a humidity level value which is considered sufficiently low not to affect the operation of the fuel cell 3 on restart or its service life.

According to an alternative, the operation of the internal combustion engine 2 in step d) is maintained for a predetermined time interval. Thus it is possible to avoid the costs linked to installation of a humidity sensor for measuring the humidity level in the fuel cell 3.

The time interval is determined, for example, as a function of predefined tests, or may correspond to an estimate of a time interval allowing drying of the fuel cell 3 to a level considered sufficient.

As illustrated in FIG. 2, the internal combustion engine 2 may be coupled to a turbocompressor 18 positioned on the pipe C1. The turbocompressor 18 is thus arranged upstream of the air inlet 12 of the internal combustion engine 2 and downstream of the fuel cell 3.

In the example illustrated, the common portion C3 of the pipes C1 and C2 is connected upstream of an air inlet of the turbocompressor 18.

It could be provided that, in the absence of a common portion C3, each of the pipes C1 and C2 is connected independently upstream of the air inlet of the turbocompressor 18.

In an embodiment, in addition to the running of the internal combustion engine 2 in step d), the turbocompressor 18 could be run in order to provide more power for the drawing of fluids present in the fuel cell 3 towards the internal combustion engine 2.

In this respect, the control device 19 may be configured to provoke the running of the turbocompressor 18 in step d) or after step d).

1-11. (canceled)

12. A method for managing a hybrid powertrain of a hydrogen motor vehicle, comprising an internal combustion engine, a fuel cell, a hydrogen storage tank, and a first pipe which connects an air outlet of the fuel cell to an air inlet of the internal combustion engine and comprises a first cut-off valve, the method comprising the following steps:
a) provoking a shut-down of the fuel cell;
b) provoking a shut-down of the internal combustion engine;
c) when the fuel cell and the internal combustion engine have shut down, opening the first cut-off valve; and
d) when the first cut-off valve is open, running the internal combustion engine without an injection of hydrogen originating from the storage tank in order to draw fluids present in the fuel cell towards the internal combustion engine via the first pipe.

13. The method as claimed in claim 12, wherein the powertrain comprises a second pipe which connects a hydrogen outlet of the fuel cell to the air inlet of the internal combustion engine and comprises a second cut-off valve, step c) further comprising the opening of the second cut-off valve in order to draw the fluids present in the fuel cell towards the internal combustion engine via the second pipe in step d).

14. The method as claimed in claim 12, wherein the running of the internal combustion engine in step d) is maintained during a predetermined time interval.

15. The method as claimed in claim 12, wherein the running of the internal combustion engine in step d) is maintained until a humidity level in the fuel cell is less than or equal to a predetermined threshold value.

16. A hybrid powertrain for a hydrogen motor vehicle, comprising:
an internal combustion engine;
a fuel cell;
a hydrogen storage tank;
a first pipe which connects an air outlet of the fuel cell to an air inlet of the internal combustion engine and comprises a first cut-off valve for selective passage of fluids present in the fuel cell from said air outlet towards the internal combustion engine; and
a control device configured to provoke opening of the first cut-off valve when the fuel cell and the internal combustion engine have shut down, and to run the internal combustion engine without an injection of hydrogen originating from the tank in order to draw the fluids present in the fuel cell towards the internal combustion engine via the first pipe.

17. The powertrain as claimed in claim 16, further comprising a second pipe which connects a hydrogen outlet of the fuel cell to the air inlet of the internal combustion engine and comprises a second cut-off valve for the selective passage of the fluids present in the fuel cell from said hydrogen outlet towards the internal combustion engine, the control device being configured to provoke opening of the second cut-off valve before a start-up of the internal combustion engine without the injection of hydrogen in order to draw the fluids present in the fuel cell towards the internal combustion engine via the second pipe.

18. The powertrain as claimed in claim 17, wherein the powertrain comprises a recirculation unit connected to the fuel cell for recirculation of hydrogen from the hydrogen outlet towards a hydrogen inlet of the fuel cell, the recirculation unit being connected to the second pipe.

19. The powertrain as claimed in claim 17, wherein the second pipe is connected to the first pipe upstream of the air inlet of the internal combustion engine.

20. The powertrain as claimed in claim 17, further comprising at least one condenser positioned on the first pipe or the second pipe.

21. The powertrain as claimed in claim 16, wherein the internal combustion engine is coupled to a turbocompressor positioned on the first pipe, upstream of the air inlet of the internal combustion engine and downstream of the fuel cell.

22. A motor vehicle comprising:
a hybrid powertrain, the hybrid powertrain comprising:
an internal combustion engine;
a fuel cell;
a hydrogen storage tank;
a first pipe which connects an air outlet of the fuel cell to an air inlet of the internal combustion engine and comprises a first cut-off valve for selective passage of fluids present in the fuel cell from said air outlet towards the internal combustion engine; and
a control device configured to provoke opening of the first cut-off valve when the fuel cell and the internal combustion engine have shut down, and to run the internal combustion engine without an injection of hydrogen originating from the tank in order to draw the fluids present in the fuel cell towards the internal combustion engine via the first pipe.
